(19) United States
(12) Patent Application Publication
(10) Pub. No.: US 2024/0362205 A1
(43) Pub. Date: Oct. 31, 2024

(54) AUTO-SCALING PROGRAMMING FRAMEWORK TO HANDLE DATA EXPLOSIONS ASSOCIATED WITH BIG DATA

(71) Applicant: SAP SE, Walldorf (DE)

(72) Inventors: Hongjun Qian, Shanghai (CN); Xuchen Wang, Shanghai (CN)

(21) Appl. No.: 18/308,127

(22) Filed: Apr. 27, 2023

(51) Int. Cl. G06F 16/23

(52) U.S. Cl. CPC G06F 16/2386

(57) ABSTRACT

In some embodiments, there is provided a method including receiving a first package for processing as part of a job; unpacking the first package to include additional data linked to the first package, wherein the first package including the additional data forms a first unpacked package; in response to the first unpacked package being less than a package threshold size, processing the first unpacked package to form a first output; and in response to the first unpacked data being more than the package threshold size, rescaling the first package to satisfy the package threshold size before additional unpacking and processing is performed on the first package. Related manufactured articles, devices, systems, and methods are also disclosed.

### TECHNICAL FIELD

The disclosed subject matter generally relates to processing optimization and more particularly to auto-scaling of batch job processing.

### BACKGROUND

Daily activities of analytic systems serving multiple customers consume an increasing amount of processing resources of a shared multithreaded server. Data activities may include multiple jobs. Each job can be triggered daily at a particular time. For example, the timesheets of all the employees of an entity are processed daily. For some jobs, the execution of the job on a large data set would utilize too many resources that would lead to crowding out other jobs from other users and sometimes system failures where the job would either not get completed on time or completed with errors.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, manufactured articles, devices, systems, and methods are provided for an auto-scaling framework for jobs. In some embodiments, there is provided a method including receiving a first package for processing as part of a job; unpacking the first package to include additional data linked to the first package, wherein the first package including the additional data forms a first unpacked package; in response to the first unpacked package being less than a package threshold size, processing the first unpacked package to form a first output; and in response to the first unpacked data being more than the package threshold size, rescaling the first package to satisfy the package threshold size before additional unpacking and processing is performed on the first package.

Implementations may include one or more of the following features. The unpacking of the first package may include determining that the first package includes data that is linked to the additional data at a data store and obtaining, via the link, the additional data from the data store, wherein the first unpacked package comprises the data and the additional data. The first unpacked package may be checked to determine whether the first unpacked package is less than the package threshold size. In response to the unpacking of the first package not being linked to the additional data, the first package may be processed to provide a second output. The rescaling may include splitting, based on the package threshold size, the first package into a plurality of packages comprising a second package and a third package. The method may further include unpacking the second package and/or in response to the unpacking of the second package being less than the package threshold size, processing the second package to form a corresponding output. The method may further include unpacking the third package and/or in response to the unpacking of the third package being less than the package threshold size, processing the third package to provide a corresponding output. The second package and the third package may be processed in parallel to form corresponding outputs. The second package and the third package may be processed serially to form corresponding outputs. The method may further include receiving, at a job execution system, a batch job comprising the job associated with at least the first package.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an example of a system for auto-scaling of jobs of a batch process, in accordance with some embodiments;

FIG. 2 illustrates an example of a process for auto-scaling of jobs of a batch process, in accordance with some embodiments;

FIG. 3 illustrates another example of a system including an auto-scaling framework, in accordance with some embodiments;

FIG. 4 depicts an example of processing packages, in accordance with some embodiments;

FIG. 5 depicts another example of an auto-scaling process, in accordance with some example implementations; and

FIG. 6 depicts another example of a system, in accordance with some embodiments.

Where practical, the same or similar reference numbers denote the same or similar or equivalent structures, features, aspects, or elements, in accordance with one or more embodiments.

### DETAILED DESCRIPTION

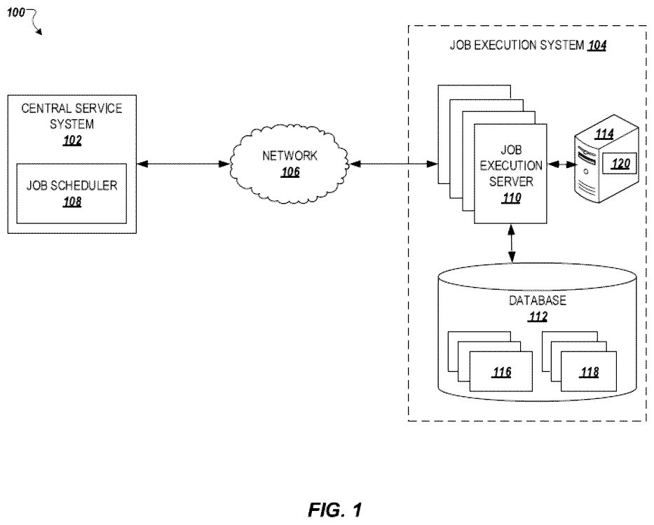

FIG. 1 illustrates an example of a system 100 for auto-scaling of jobs, such as jobs of a batch process, in accordance with some embodiments. The system 100 may be configured to automatically detect if a package for a job exceeds a package threshold size and, if the threshold is exceeded, return the package (or a portion of the package), so that the package can be repackaged to not exceed the package threshold size. The system 100 may include a central service system 102 that can communicate with a job execution server 104 via a network 106.

Although some of the examples refer to the central service system 102 and the job scheduler 108 as being separate from the job execution system 104 and the database 112 (as thus coupled via network 106), the central service system 102 and job scheduler 108 may instead be located on the same system as the job execution system 104 and the database 112, in which case a system call (e.g., RFC, function call, etc.) may be used to call the job execution system and/or the database.

The central service system 102 may include at least one computer system. For example, the central service system 102 may include a general purpose computer, a handheld mobile device, a tablet, or other communication capable device, sensor, or monitor. The central service system 102 may also include one or more processors and the job scheduler 108. The job scheduler 108 may include a memory coupled to the one or more processors of the central service system 102. The memory of the job scheduler 108 may include a non-transitory computer-readable or machine-readable storage medium that can include, encode, store, or the like one or more programs that cause the one or more processors of the central service system 102 to schedule execution of jobs (e.g., jobs, batch jobs, other types of jobs) on the job execution system 104, as described herein. For example, an end-user may have one or more jobs, such as a batch job, to be processed by the job execution system. In this example, the job scheduler 108 sends a request to the job execution system 104 to perform the batch job. The request may include when the batch job should be performed (e.g., time of day), the type of batch processing requested (e.g., serially, in parallel, and/or other type of processing requirement), a deadline to complete the job, one or more containers (which include an image of the batch job and/or the data (or package) to be processed by the batch job), and/or a link (or location) of where the one or more containers and/or data are located. After the batch job is completed by the job execution system 104, the job execution system 104 may return the results to the central service system 102 or another client device.

In some instances, the job scheduler 108 may trigger daily execution of one or more batches of job(s) and execution of one or more batches, wherein each batch is a sub-set of the entire data set and a sub-job (or, e.g., job) executes on a single batch. The results of plurality of sub-jobs executing on each batch taken together form the results of a larger job. The job execution system 104 may be configured to identify jobs that are too small (e.g., below a size threshold) to be divided up into sub-jobs/batches and/or to identify jobs that are too large (e.g., over a size threshold) which need to be divided up into sub-jobs/batches. Job scheduler 108 may process job data received from the job execution system 104 stored in database 112 to schedule subsequent job and sub-job execution. In alternative implementations, the database 112 may be shared by central service system 102 and job execution system 104 or be integrated into central service system 102.

As shown in FIG. 1, the central service system 102 can be communicatively coupled with the job execution system 104 to transmit, over the network 106 for example, the job and sub-job request data as well as any necessary output data resulting from the execution of the job. It should be appreciated that the network 106 can be any wired and/or wireless network including, for example, a public land mobile network (PLMN), a local area network (LAN), a wide area network (WAN), the Internet, a cellular network, a telephone network (e.g., PSTN) or an appropriate combination thereof connecting any number of communication devices, mobile computing devices, fixed computing devices, server systems, and/or the like.

The job execution system 104 may include one or more multiple job execution servers 110, a database 112 configured to store job history data 116 and tenant or customer data 118 to be processed during jobs (also referred to as batch jobs). Tenant data 118 can be any data that a tenant or customer stores as part of its operations. Examples of tenant data 118 can include employee timesheet data, payroll data, purchase order data, invoice documents, financial documents, and/or other types of data. As a further example, tenant data 118 can include large data sets such as employee records for 100,000 employees that require processing by a job. It should also be noted that different tenants can process the same kinds of data (e.g., timesheet data) but do so in different ways to conform to individual best practices as well as potential regulatory restrictions depending on location. Because of these processing differences across tenants and customers, it is important to track each tenant or customer job execution history to provide optimal batch sizing for each tenant or customer. Job execution system 104 may also include computing system 114 configured to optimize execution of the jobs executed by the job execution servers 110. In some implementations, the job execution system 104 and/or any of its components can be incorporated and/or part of a container system (e.g., Kubernetes and/or other types of containers) that can be used in cloud implementations. The job execution servers 110 can include any form of servers including, a web server (e.g., cloud-based server), an application server, a proxy server, a network server, and/or a server pool. The job execution servers 110 may accept requests to execute a plurality of jobs as well as sub-jobs and generate job history data 116 that enables job processing optimization. The job execution servers 110 can include multiple threads that can process a batch (a portion of a data set) having a particular size that is below a threshold size. The job execution servers 110 can include a customizing engine, a development system, a test system, and a production system. The job execution servers 110 can include running instances of corresponding executables (e.g., .exe files) included in the database 112. It should be appreciated that the database 112 can also include other executable (e.g., .exe files) required for running the job execution system 104. In some implementations, an executable can be a computer program that have already been compiled into machine language and is therefore capable of being executed directly by a data processor. The job execution servers 110 may also execute jobs serially and/or in parallel.

The database 112 can be any type of database including, for example, an in-memory database, a relational database, a non-SQL (NoSQL) database, and/or the like. As shown in FIG. 1, the database 112 can be a dedicated, single-container database system running a single instance of the job execution servers 110. However, where the database 112 implements a multitenant database architecture (e.g., multitenant database containers (MDC)), each tenant of the database 112 can be served by separate instances of the job execution servers 110. In some implementations, the database 112 may store the job history data 116 received from job execution servicers 110 based on a job data type and tenant identification data. This data can be part of header information or otherwise indicated by attributes or tags (e.g., data or metadata defining a type, quality, source, or attribute associated with the job data). The database 112 may transmit the collected job history data to the central service system 102. The central service system 102 may include hardware or software implementations (e.g., applications or software objects instantiated over one or more computing systems) that may process job history data received, to assist job scheduler 108 in scheduling jobs and sub-jobs. This can be done either independently by job scheduler 108 or in association with the computing system 114.

The computing system 114 and/or servers 110 can be and/or include any type of processor and memory based device, such as a general purpose computer, a handheld mobile device, a tablet, or other communication capable device, sensor or monitor. The computing system 114 can include a batch size determiner 120. The batch size determiner 120 can include a software or hardware implemented device configured to analyze job history data 116 to optimize execution of jobs by the job execution servers 110. The batch size determiner 120 can include a dedicated application or other type of software application, in communication with, or running either fully or partially on the computing system 114. It is noteworthy that the computing system 114 and other software or hardware elements of the job execution system 104 associated with optimizing execution of jobs may be implemented over a centralized or distributed (e.g., cloud-based) computing environment as dedicated resources or may be configured as virtual machines that define shared processing or storage resources. The batch size determiner 120 may also determine a package size threshold for a job. This package size threshold may be used to determine whether a package being executed by a job needs to be rescaled (e.g., made smaller) before execution of the job.

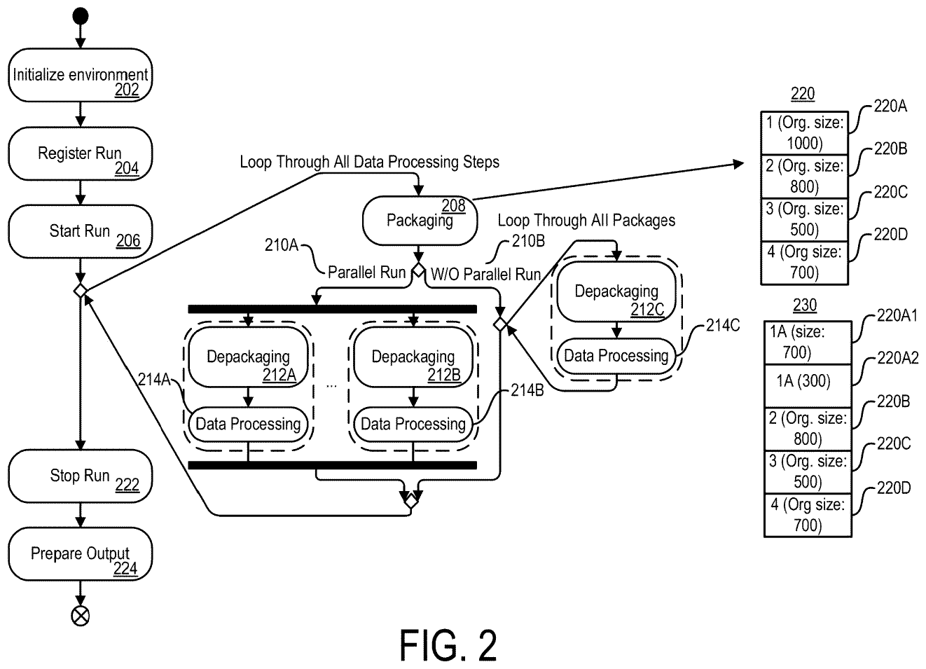

FIG. 2 depicts an example of a process for executing an auto-scaling process, in accordance with some embodiments. The auto-scaling may rescale a package of a job so that the package does not exceed a package size threshold. In this way, execution of the package may be optimized and thus avoid data processing of the package taking too long to complete or causing a time out or an error.

At 202, the environment may be initialized. For example, the job execution system 104 and/or job execution server 110 may initialize the environment for execution of the batch job(s). This may include initializing global variables, preparing an operating or a running context for the job(s) including for example recording a starting time point for job execution, getting utilities from other components, and/or the like. At 204, the batch job may be registered for the run, so that it can be executed by the job execution server 110.

At 206, the batch job is run. For example, the run may including receiving a package to be executed for the job. The package may include one or more chunks of data to be processed during the run, although the package may also include code (e.g., an image) and/or other metadata or information for executing the job(s). Moreover, the data chunks may be schedule to be executed in parallel and/or serially. For example, the chunks of data may be packaged so that it is less than a package size threshold, which enables the package to be efficiently processed during the execution or run.

In the example of FIG. 2, the chunks of data to be processed during the batch job are packaged into 4 separate packages as shown at 220, which in this example are a first package 220A of 1000 records, a second package 220B of 800 records, a third package 220C of 500 records, and a fourth package of 700 records. The packages may be formed by the job execution server 110, for example.

At 208, the packages 220A-D are received and each of the data packages are scheduled for execution as a parallel batch processing run 210A or without using a parallel run 210B (e.g., serially). For example, the job execution server 110 may receive the packages at 208 and schedule the packages 220A-D for execution.

At 212A, a package is depackaged for processing (which in this example is a parallel run). When the package is depackaged (or unpacked) for data processing, the package may include for example documents, records, and/or other data (or objects) to be processed. However, until the depackaging at 212A, the system cannot truly tell the size of a package. Supposing for example first package 220A is unpacked at 212A. During the unpacking at 212A, the first package's data may include documents related to reconciling an account as part of a yearend reconciliation. In this example, the documents in the package may actually be linked in the database 112 to millions of other, additional documents that also have to be processed 214A during the run to perform the reconciliation. In this example, the size of the job to be executed at 214A has increased dramatically (e.g., above a package size threshold), so the efficiency of the data processing step 214A is compromised. In other words, the larger package may cause the data processing step 214A to take too long to complete (e.g., longer than originally scheduled or longer than a threshold amount of time), to time out, or to flag an error.

In some embodiments, during the depackaging at 212A for example, a package, such as the first package 220A, is evaluated (as well as data linked to the package 220A which also needs to be included in the package 220, for example) to make sure the first package is less than a given package size threshold. If so, the depackaging 212A can continue to the data processing at 214A. If less than the package threshold size, the package, such as the first package 220A, is sent back to packaging 208 to re-scale (e.g., re-size and re-package) the first package 220A so that first package 220A is less than the package size threshold. The depackaging 212A may also indicate to the packaging 208 the size of the returned first package 220A (e.g., the size after all of the linked data is incorporated into the package 220A). In this example, the packaging 208, de-packaging 212A, and data processing 214A may be performed by the job execution server 110.

After the first package 220A is repackaged at 208, the repackaged package 230 may be formed as shown at FIG. 2. For example, the first package 220A may be split into smaller pacakges 220A1 and 220A2, both of which are below a package size threshold of 850, for example. With the repackaging, the repackage packages 220A1 and 220A2 are each depackaged at 212A and 212B, respectively. When a package is depackaged (or unpacked), the package may include for example documents, records, and/or other data object to be processed. If the unpacking of packages 220A1 or 220A2 does not yield an increase in size above the package size threshold, the packages 220A1-A2 may then be processed at data processing steps 214A-B, respectively. If the unpacking yields another increase in size above the package size threshold, the package may again be returned to packaging 208 for repacking. This process may repeat (e.g., loop through the packages) until all of the packages to be processed at 214A-C are below the package size threshold. When the packages undergo data processing 214A-C (with packages under the package size threshold), the batch job can stop at 222 and the results may be prepared and provided as an output 224 (and the completion reported to the job scheduler 108.

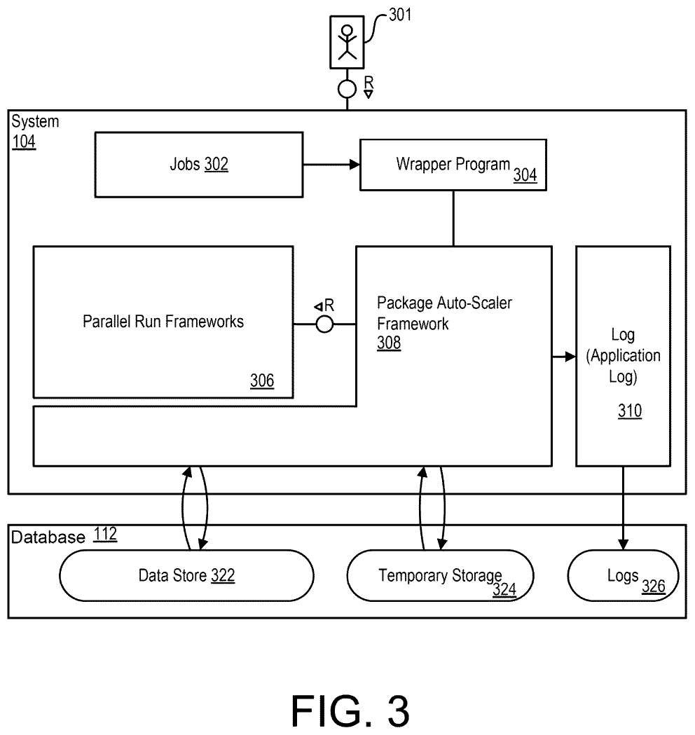

FIG. 3 depicts an example of a job execution system 104 including a package auto-scaler framework 308, in accordance with some embodiments. The job execution system may include one or more job (e.g., batch jobs) 302 including one or more packages. The jobs may be received from a client device 301 or a central service system 102 (including the job scheduler 108). The jobs may be wrapped in a wrapper program, which may execute with or without jobs being presented and/or may trigger execution of the auto-scaling disclosed herein. The job execution system may further include a parallel run framework 306, although as noted the jobs may be executed serially as well. The parallel run framework enables the packages to be executed in parallel as shown at FIG. 2, for example.

The job execution system 104 of FIG. 3 may also include a package auto-scaler framework 308 (or auto-scaler, for short), in accordance with some embodiments. The auto-scaler 308 may receive one or more packages for execution and evaluate each package to ensure that the package is below a package size threshold. For example, when a package is unpacked or depackaged as noted above, the auto-scaler may assess the size of the package. Moreover, the auto-scaler may assess whether the package requires additional dependent data to be incorporated into the package which can increase the size of the package. To determine the dependent data, the auto-scaler may follow the dependencies (e.g., links) of the data of a package (which may include making one or more calls to database 112, for example). During the unpacking (e.g., the noted depackaging noted at 212A above), data records found in a package may be linked (e.g., via key-value pairs) to other records which need to be incorporated into the package before data processing of the package. If the incorporated data causes the size to exceed the package size threshold, the auto-scaler returns the package (e.g., to packaging 208) for repacking below a package size threshold.

The job execution system 104 of FIG. 3 may also include a log 310 that stores a record of the jobs performed, package threshold sizes used, and/or packages returned for repackaging. In the example of FIG. 3, the job execution system interfaces one or more databases, such as the database 112. For example, the noted client data, tenant data, and/or other data for a package may be stored in storage 322. The temporary storage 324 may be used to store intermediate results, such as data created by a first step of data processing so it can be used in another step in the data processing. Moreover, the logs may be stored at 326 as well. In some embodiments, the package threshold size is the same for a plurality of jobs. Alternatively, or additionally, different package threshold sizes may be used from some of the jobs. In some embodiments, the package threshold size is determined based on historical execution of jobs.

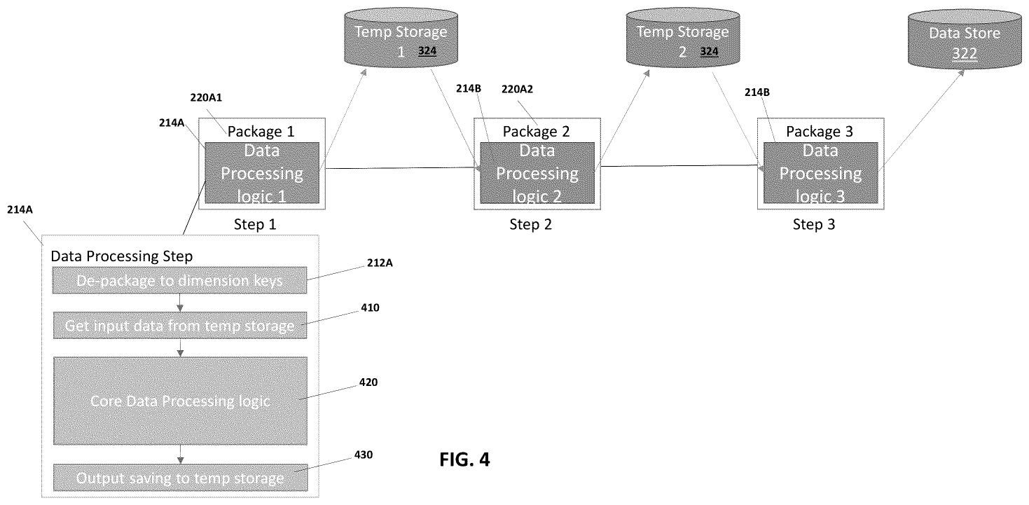

FIG. 4 depicts another example of processing the packages, in accordance with some embodiments. FIG. 4 is similar to the processing noted above with respect to FIG. 1 but further illustrates the use of temporary storage, such as the temporary storage 324. In the example of FIG. 4, the first package 220A is processed in the data processing step 214A. The data processing step includes depackaging at 212A the package 220A and assessing whether the size of the package 220A exceeds the noted package size threshold. If not, input data for the package 220A may be obtained at 410 from temporary storage 324. At 420, the data processing continues by executing the logic or code for the package data. At 430, the output of the processing at 420 may be stored to temporary storage 412 to allow the next package 220A2 to use at least a portion of the package's data. This may repeat at 214B and 214C and so forth until the package processing is complete and the output is stored (e.g., at data store 322) and/or returned as a response (e.g., to the central service system 102 or client device 301).

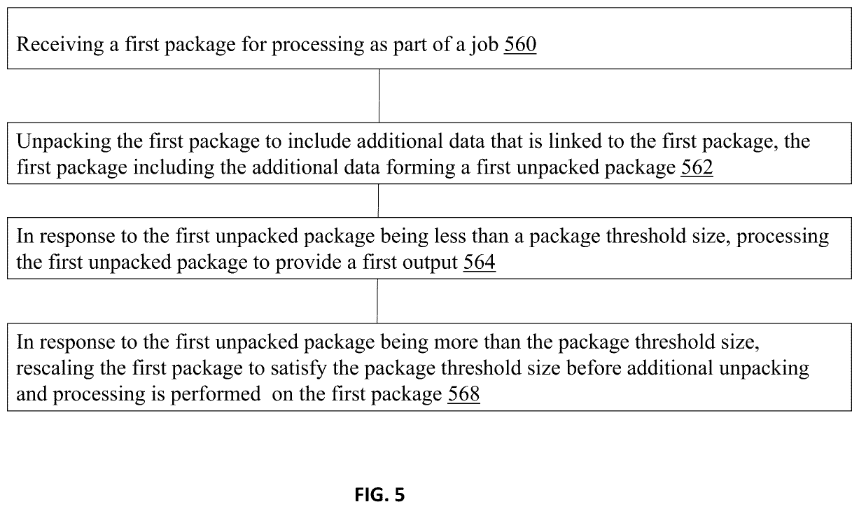

FIG. 5 depicts an example of a process for auto-scaling, in accordance with some embodiments.

At 560, the process may include receiving a first package for processing as part of a job, in accordance with some embodiments. For example, a first package, such as package 220A, may be received by the job execution system 104 from a client, such as client device 301, a central service system 102, and/or the like. The first package 220A may be received with other packages as part of a batch of jobs, such as jobs 302.

At 562, the first package may be unpacked such that it includes additional data linked to the first package, wherein the first package including the additional data forms a first unpacked package, in accordance with some embodiments. For example, the first package 220A may be received by the auto-scaler 308, and depackaging 212A (e.g., unpacking) may indicate that the first package 220A is linked to additional data. To illustrate further, the depackaging 212A may follow links or keys in the first package 212A to the additional data that should be incorporated into the first data package. This additional data may be stored in database 112 (or data store 322) and may be retrieved by the auto-scaler. For example, the first data package 212A may include an invoice document but the invoice document is linked to other purchasing documents in the data store 322, and these other purchasing documents should be executed at data processing 214A with the invoice documents. In this example, the first package (which includes the additional data) forms a first unpacked package.

At 564, in response to the first unpacked package being less than a package threshold size, the first unpacked package may be processed to provide a first output, in accordance with some embodiments. As noted, the first package including the linked additional data from a first unpacked package. The auto-scaler 308 may check (e.g., determine) if the first unpacked package is less than a package threshold size. If so, the depackaging 212A of the auto-scaler 308 may run the first unpacked package as part of a job at processing 214A, for example. And, the output of that run may provide a first output.

In response to the first unpacked package being more than the package threshold size, the first package may, at 568, be rescaled to satisfy the package threshold size before additional unpacking and processing is performed on the first package in accordance with some embodiments. If the first package including the linked additional data (which forms the first unpacked package) is greater than the package threshold size, the depackaging 212A of the auto-scaler 308 may repackage the first package such that it is rescaled to satisfy the package threshold size. Referring the example above, the first package 220A is rescaled to packages 220A1 and 220A2 before additional depackaging 212A-B and processing 214A-B is performed.

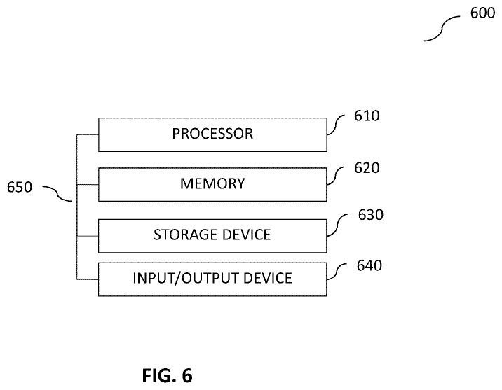

In some implementations, the current subject matter may be configured to be implemented in a system 600, as shown in FIG. 6. For example, the job execution system 104, job execution server 110, system 100 (or one or more aspects therein), and/or system 300 (or one or more aspects therein) may be at least in part physically comprised on system 600. To illustrate further system 1100 may further an operating system, a hypervisor, and/or other resources, to provide virtualize physical resources (e.g., via virtual machines). The system 600 may include a processor 610, a memory 620, a storage device 630, and an input/output device 640. Each of the components 610, 620, 630 and 640 may be interconnected using a system bus 650. The processor 610 may be configured to process instructions for execution within the system 600. In some implementations, the processor 610 may be a single-threaded processor. In alternate implementations, the processor 610 may be a multi-threaded processor.

The processor 610 may be further configured to process instructions stored in the memory 620 or on the storage device 630, including receiving or sending information through the input/output device 640. The memory 620 may store information within the system 600. In some implementations, the memory 620 may be a computer-readable medium. In alternate implementations, the memory 620 may be a volatile memory unit. In yet some implementations, the memory 620 may be a non-volatile memory unit. The storage device 630 may be capable of providing mass storage for the system 600. In some implementations, the storage device 630 may be a computer-readable medium. In alternate implementations, the storage device 630 may be a floppy disk device, a hard disk device, an optical disk device, a tape device, non-volatile solid state memory, or any other type of storage device. The input/output device 640 may be configured to provide input/output operations for the system 600. In some implementations, the input/output device 640 may include a keyboard and/or pointing device. In alternate implementations, the input/output device 640 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1: A computer-implemented method comprising: receiving a first package for processing as part of a job; unpacking the first package to include additional data linked to the first package, wherein the first package including the additional data forms a first unpacked package; in response to the first unpacked package being less than a package threshold size, processing the first unpacked package to form a first output; and in response to the first unpacked data being more than the package threshold size, rescaling the first package to satisfy the package threshold size before additional unpacking and processing is performed on the first package.

Example 2: The computer-implemented method of Example 1, wherein the unpacking the first package further comprises determining that the first package includes data that is linked to the additional data at a data store and obtaining, via the link, the additional data from the data store, wherein the first unpacked package comprises the data and the additional data.

Example 3: The computer-implemented method of any of Examples 1-2, further comprising: checking the first unpacked package to determine whether the first unpacked package is less than the package threshold size.

Example 4: The computer-implemented method of any of Examples 1-3, wherein in response to the unpacking of the first package not being linked to the additional data, processing the first package to provide a second output.

Example 5: The computer-implemented method of any of Examples 1-4, wherein the rescaling further comprises splitting, based on the package threshold size, the first package into a plurality of packages comprising a second package and a third package.

Example 6: The computer-implemented method of any of Examples 1-5, further comprising: unpacking the second package; and in response to the unpacking of the second package being less than the package threshold size, processing the second package to form a corresponding output.

Example 7: The computer-implemented method of any of Examples 1-6, further comprising: unpacking the third package; and in response to the unpacking of the third package being less than the package threshold size, processing the third package to provide a corresponding output.

Example 8: The computer-implemented method of any of Examples 1-7, wherein the second package and the third package are processed in parallel to form corresponding outputs.

Example 9: The computer-implemented method of any of Examples 1-8, wherein the second package and the third package are processed serially to form corresponding outputs.

Example 10: The computer-implemented method of any of Examples 1-9 further comprising: receiving, at a job execution system, a batch job comprising the job associated with at least the first package.

Example 11: A system comprising: at least one processor; and at least one memory including instructions which when executed by the at least one processor causes operations comprising: receiving a first package for processing as part of a job; unpacking the first package to include additional data linked to the first package, wherein the first package including the additional data forms a first unpacked package; in response to the first unpacked package being less than a package threshold size, processing the first unpacked package to provides a first output; and in response to the first unpacked data being more than the package threshold size, rescaling the first package to satisfy the package threshold size before additional unpacking and processing is performed on the first package.

Example 12: The system of Example 11, wherein the unpacking the first package further comprises determining that the first package includes data that is linked to the additional data at a data store and obtaining, via the link, the additional data from the data store, wherein the first unpacked package comprises the data and the additional data.

Example 13: The system of any of Examples 11-12, further comprising: checking the first unpacked package to determine whether the first unpacked package is less than the package threshold size.

Example 14: The system of any of Examples 11-13, wherein in response to the unpacking of the first package not being linked to the additional data, processing the first package to provide a second output.

Example 15: The system of any of Examples 11-14, wherein the rescaling further comprises splitting, based on the package threshold size, the first package into a plurality of packages comprising a second package and a third package.

Example 16: The system of any of Examples 11-15, further comprising: unpacking the second package; and in response to the unpacking of the second package being less than the package threshold size, processing the second package to form a corresponding output.

Example 17: The system of any of Examples 11-16, further comprising: unpacking the third package; and in response to the unpacking of the third package being less than the package threshold size, processing the third package to provide a corresponding output.

Example 18: The system of any of Examples 11-17, wherein the second package and the third package are processed in parallel to form corresponding outputs.

Example 19: The system of any of Examples 11-18, wherein the second package and the third package are processed serially to form corresponding outputs.

Example 20: A non-transitory computer readable storage medium including instructions which when executed by at least one processor causes operations comprising: receiving a first package for processing as part of a job; unpacking the first package to include additional data linked to the first package, wherein the first package including the additional data forms a first unpacked package; in response to the first unpacked package being less than a package threshold size, processing the first unpacked package to provides a first output; and in response to the first unpacked data being more than the package threshold size, rescaling the first package to satisfy the package threshold size before additional unpacking and processing is performed on the first package.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order. to achieve desirable results. Other implementations can be within the scope of the following claims

What is claimed is:

1. A computer-implemented method comprising:
receiving a first package for processing as part of a job;
unpacking the first package to include additional data linked to the first package, wherein the first package including the additional data forms a first unpacked package;
in response to the first unpacked package being less than a package threshold size, processing the first unpacked package to form a first output; and
in response to the first unpacked data being more than the package threshold size, rescaling the first package to satisfy the package threshold size before additional unpacking and processing is performed on the first package.

2. The computer-implemented method of claim 1, wherein the unpacking the first package further comprises determining that the first package includes data that is linked to the additional data at a data store and obtaining, via the link, the additional data from the data store, wherein the first unpacked package comprises the data and the additional data.

3. The computer-implemented method of claim 1, further comprising:
checking the first unpacked package to determine whether the first unpacked package is less than the package threshold size.

4. The computer-implemented method of claim 1, wherein in response to the unpacking of the first package not being linked to the additional data, processing the first package to provide a second output.

5. The computer-implemented method of claim 1, wherein the rescaling further comprises splitting, based on the package threshold size, the first package into a plurality of packages comprising a second package and a third package.

6. The computer-implemented method of claim 5, further comprising:
unpacking the second package; and
in response to the unpacking of the second package being less than the package threshold size, processing the second package to form a corresponding output.

7. The computer-implemented method of claim 5, further comprising:
unpacking the third package; and
in response to the unpacking of the third package being less than the package threshold size, processing the third package to provide a corresponding output.

8. The computer-implemented method of claim 5, wherein the second package and the third package are processed in parallel to form corresponding outputs.

9. The computer-implemented method of claim 5, wherein the second package and the third package are processed serially to form corresponding outputs.

10. The computer-implemented method of claim 1 further comprising:
receiving, at a job execution system, a batch job comprising the job associated with at least the first package.

11. A system comprising:
at least one processor; and
at least one memory including instructions which when executed by the at least one processor causes operations comprising:
receiving a first package for processing as part of a job;
unpacking the first package to include additional data linked to the first package, wherein the first package including the additional data forms a first unpacked package;
in response to the first unpacked package being less than a package threshold size, processing the first unpacked package to provides a first output; and
in response to the first unpacked data being more than the package threshold size, rescaling the first package to satisfy the package threshold size before additional unpacking and processing is performed on the first package.

12. The system of claim 11, wherein the unpacking the first package further comprises determining that the first package includes data that is linked to the additional data at a data store and obtaining, via the link, the additional data from the data store, wherein the first unpacked package comprises the data and the additional data.

13. The system of claim 11, further comprising:
checking the first unpacked package to determine whether the first unpacked package is less than the package threshold size.

14. The system of claim 11, wherein in response to the unpacking of the first package not being linked to the additional data, processing the first package to provide a second output.

15. The system of claim 11, wherein the rescaling further comprises splitting, based on the package threshold size, the first package into a plurality of packages comprising a second package and a third package.

16. The system of claim 15, further comprising:
unpacking the second package; and
in response to the unpacking of the second package being less than the package threshold size, processing the second package to form a corresponding output.

17. The system of claim 15, further comprising:
unpacking the third package; and
in response to the unpacking of the third package being less than the package threshold size, processing the third package to provide a corresponding output.

18. The system of claim 15, wherein the second package and the third package are processed in parallel to form corresponding outputs.

19. The system of claim 15, wherein the second package and the third package are processed serially to form corresponding outputs.

20. A non-transitory computer readable storage medium including instructions which when executed by at least one processor causes operations comprising:
receiving a first package for processing as part of a job;
unpacking the first package to include additional data linked to the first package, wherein the first package including the additional data forms a first unpacked package;
in response to the first unpacked package being less than a package threshold size, processing the first unpacked package to provides a first output; and
in response to the first unpacked data being more than the package threshold size, rescaling the first package to satisfy the package threshold size before additional unpacking and processing is performed on the first package.
